(19) United States
(12) Patent Application Publication
(10) Pub. No.: US 2014/0095569 A1
(43) Pub. Date: Apr. 3, 2014

(54) ORTHOGONAL CODE MATRIX GENERATION METHOD AND RELATED CIRCUIT THEREOF

(71) Applicant: RAYDIUM SEMICONDUCTOR CORPORATION, Hsinchu (TW)

(72) Inventors: Shih-Lun Huang, Hsinchu City (TW); Kai-Ming Liu, Hsinchu County (TW)

(73) Assignee: Raydium Semiconductor Corporation, Hsinchu (TW)

(21) Appl. No.: 13/733,144

(22) Filed: Jan. 3, 2013

(30) Foreign Application Priority Data
Sep. 28, 2012 (TW) 101135993

(51) Int. Cl. G06F 17/16

(52) U.S. Cl. CPC G06F 17/16
USPC 708/520

(57) ABSTRACT

An orthogonal code matrix generation method includes: establishing an N×N orthogonal code matrix, wherein an inner product of every two rows of the orthogonal code matrix is 0, and each column of the orthogonal code matrix has a summation of elements equal to a same value, wherein N is a power of 4; and using the N×N orthogonal code matrix as a basic unit to establish a target orthogonal code matrix. An orthogonal code matrix generation circuit includes: an N×N orthogonal code matrix generator, arranged for establishing an N×N orthogonal code matrix, wherein an inner product of every two rows of the orthogonal code matrix is 0, each column of the orthogonal code matrix has a summation of elements equal to a same value; and a target orthogonal code matrix generator, arranged for using the N×N orthogonal code matrix as a basic unit to establish a target orthogonal code matrix.

### BACKGROUND OF THE INVENTION

1. Field of the Invention

The disclosed embodiments of the present invention relate to an orthogonal code matrix, and more particularly, to an orthogonal code matrix generation method and related circuit which generate an orthogonal code matrix with each column thereof has a summation of elements equal to a same value, or generate an orthogonal code matrix with less difference between summations of elements of each of columns.

2. Description of the Prior Art

The orthogonal code may be applied in various fields, for instance, the Code Division Multiple Access (CDMA) standard in the wireless communication field. The orthogonal spread spectrum technique adopted in the CDMA standard allows all the users in the same CDMA channel to exist in one chip without interfering with each other. The most common orthogonal code is Walsh code. A Walsh code with a length n is composed by an n×n matrix, wherein n is the order of the matrix, rows of the matrix are completely orthogonal to each other, and an inner product of every two rows of the matrix is 0. However, the differences between summations of elements of each of columns of the n×n matrix generated from the Walsh code are different from each other. Specifically, the differences would be linearly enlarged along with the increasing of the order of the matrix. For instance, the maximum difference between the summations of elements of each of columns of the n×n matrix generated form Walsh code would be enlarged in proportion to the increasing of the order of the matrix, and the unbalance introduced by the differences would increase the cost and complexity of the receiver design. For example, the size of the capacitor in the receiver end needs to be increased. Thus, there is a need for an innovative orthogonal code matrix generation method and related circuit to solve above-mentioned issues.

### SUMMARY OF THE INVENTION

One of the objectives of the present invention is to provide an orthogonal code matrix generation method and related circuit which generate an orthogonal code matrix with each column thereof has a summation of elements equal to a same value, or generate an orthogonal code matrix with less difference between summations of elements of each of columns, to solve the above-mentioned issues.

According to a first aspect of the present invention, an orthogonal code matrix generation method is disclosed. The orthogonal code matrix generation method includes: establishing an N×N orthogonal code matrix, wherein an inner product of every two rows of the orthogonal code matrix is 0, and each column of the orthogonal code matrix has a summation of elements equal to a same value, wherein N is a power of 4; and using the N×N orthogonal code matrix as a basic unit to establish a target orthogonal code matrix.

According to a second aspect of the present invention, an orthogonal code matrix generation circuit is disclosed. The orthogonal code matrix generation circuit includes an N×N orthogonal code matrix generator and a target orthogonal code matrix generator. The N×N orthogonal code matrix generator is arranged for establishing an N×N orthogonal code matrix, wherein an inner product of every two rows of the orthogonal code matrix is 0, and each column of the orthogonal code matrix has a summation of elements equal to a same value, wherein N is a power of 4. The target orthogonal code matrix generator, arranged for using the N×N orthogonal code matrix as a basic unit to establish a target orthogonal code matrix.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating an orthogonal code matrix generation method according to an exemplary embodiment of the present invention.

FIG. 2 is a diagram illustrating an orthogonal code matrix generation circuit according to an exemplary embodiment of the present invention.

FIG. 3 is a diagram illustrating another orthogonal code matrix generation circuit according to an exemplary embodiment of the present invention.

FIG. 4 is a diagram illustrating yet another orthogonal code matrix generation circuit according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

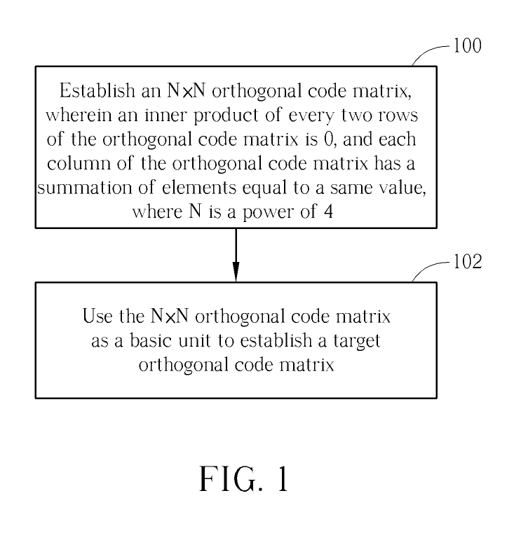

Please refer to FIG. 1, which is a flowchart illustrating an orthogonal code matrix generation method according to an exemplary embodiment of the present invention. Provided that substantially the same result is achieved, the steps of the flowchart shown in FIG. 1 need not be in the exact order shown and need not be contiguous, that is, other steps can be intermediate. Besides, some steps in FIG. 1 may be omitted according to various embodiments or requirements. The method may be briefly summarized as follows.

Step 100: Establish an N×N orthogonal code matrix, wherein an inner product of every two rows of the orthogonal code matrix is 0, and each column of the orthogonal code matrix has a summation of elements equal to a same value, where N is a power of 4; and

Step 102: Use the N×N orthogonal code matrix as a basic unit to establish a target orthogonal code matrix.

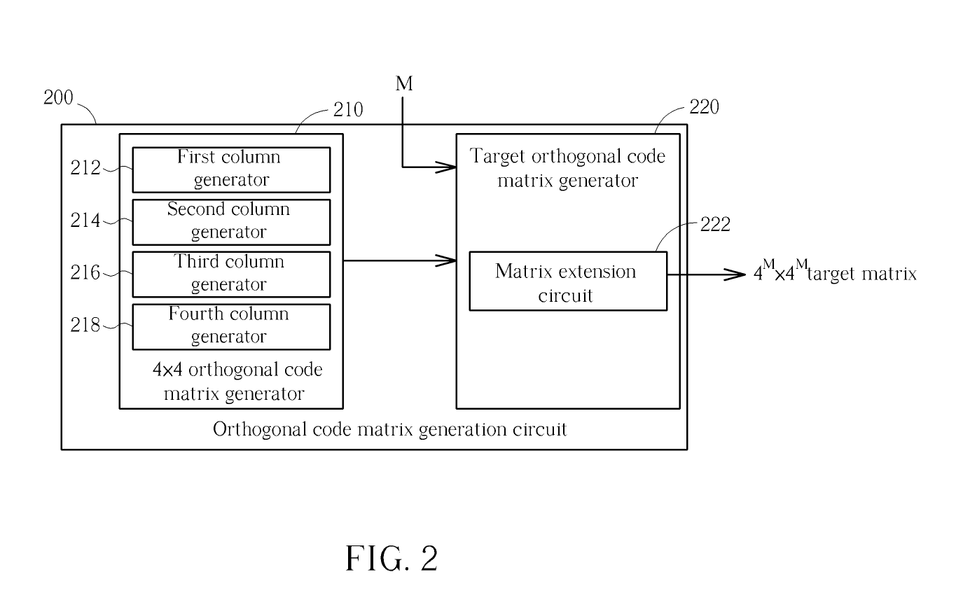

Please refer to FIG. 2, which is a diagram illustrating an orthogonal code matrix generation circuit 200 according to an exemplary embodiment of the present invention. In this embodiment, the orthogonal code matrix generation circuit 200 is used to generate a 4^{M}×4^{M} target matrix. To put it another way, the orthogonal code matrix generation circuit 200 is used to generate a matrix with an order of 4_{M}×4_{M}, wherein M is any positive integer greater than or equal to 1. It should be noted that, in the orthogonal code matrix generation circuit 200, a 4×4 orthogonal code matrix is employed as a basic unit to generate the 4_{M}×4_{M} target matrix; however, this is not a limitation of the present invention. Actually, the disclosed orthogonal code matrix generation method of the present invention may utilize any N×N orthogonal code matrix as the basic unit to establish the target matrix (premise is that the order of the target matrix should be greater than or equal to the basic unit, that is to say, 4^{M} should be greater than or equal to N), wherein N is a power of 4.

As shown in FIG. 2, in this embodiment, the orthogonal code matrix generation circuit 200 includes a 4×4 orthogonal code matrix generator 210 and a target orthogonal code matrix generator 220, wherein the 4×4 orthogonal code matrix generator 210 includes a first column generator 212, a second column generator 214, a third column generator 216, and a fourth column generator 218. The first column generator 212 is used to set one column of the N×N orthogonal code matrix by −H, H, H, and H. The second column generator 214 is used to set another column of the N×N orthogonal code matrix by H, −H, H, and H. The third column generator 216 is used to set another column of the N×N orthogonal code matrix by H, H, −H, and H. The fourth column generator 218 is used to set another column of the N×N orthogonal code matrix to H, H, H, and −H, where H is a non-zero real number. Please note that the first column generator 212, the second column generator 214, the third column generator 216, and the fourth column generator 218 mentioned above are only used for illustrating the fact that the 4×4 orthogonal code matrix generator 210 is utilized to set the elements of four columns of the 4×4 orthogonal code matrix. However, the first column generator 212, the second column generator 214, the third column generator 216, and the fourth column generator 218 are not meant to correspond to four successive columns of the 4×4 orthogonal code matrix from left to right with the exact order. To put it another way, the aforementioned four settings of four columns of the 4×4 orthogonal code matrix may be exchanged arbitrarily. Therefore, there would be 4!=24 possible settings for the 4×4 orthogonal code matrix. By way of example, but not limitation, the 4×4 orthogonal code matrix may be expressed as

$${H}_{4} = [ \begin{matrix}- H & H & H & H \\ H & - H & H & H \\ H & H & - H & H \\ H & H & H & - H\end{matrix} ]$$

$$or$$

$${H}_{4}^{′} = [ \begin{matrix}H & - H & H & H \\ - H & H & H & H \\ H & H & - H & H \\ H & H & H & - H\end{matrix} ]$$

(with the first column and the second column exchanged). It should be noticed that, either of

$${H}_{4} = [ \begin{matrix}- H & H & H & H \\ H & - H & H & H \\ H & H & - H & H \\ H & H & H & - H\end{matrix} ]$$

$$and$$

$${H}_{4}^{′} = [ \begin{matrix}H & - H & H & H \\ - H & H & H & H \\ H & H & - H & H \\ H & H & H & - H\end{matrix} ]$$

would have an inner product of every two rows of the orthogonal code matrix equal to 0; in addition, each column of the orthogonal code matrix has a summation of elements equal to a same value (i.e., 2H).

The target orthogonal code matrix generator 220 is used to employ the 4×4 orthogonal code matrix as the basic unit to establish the 4^{M}×4^{M} orthogonal code matrix (wherein M is any positive integer greater than or equal to one). The target orthogonal code matrix generator 220 includes a matrix extension circuit 222, which has a first input terminal and a second input terminal, wherein the first input terminal is used to receive the information of the order of the 4_{M}×4_{M} target matrix, and the second input terminal is used to receive the 4×4 orthogonal code matrix as the basic unit. First of all, the matrix extension circuit 222 would replace each element corresponding to a first type (e.g., H) in the 4×4 orthogonal code matrix with the 4×4 orthogonal code matrix, and multiply the 4×4 orthogonal code matrix by −1 to replace each element corresponding to a second type (e.g., −H) in the 4×4 orthogonal code matrix, to thereby generate a 4²×4² orthogonal code matrix (i.e., a 16×16 orthogonal code matrix). For instance, if each element corresponding to H in the 4×4 orthogonal code matrix is replaced by the 4×4 orthogonal code matrix, and each element corresponding to −H in the 4×4 orthogonal code matrix is replaced by the product of the 4×4 orthogonal code matrix and −1, a 16×16 orthogonal code matrix will be generated as follows:

$${H}_{16} = [ \begin{matrix}H & - H & - H & - H & - H & H & H & H & - H & H & H & H & - H & H & H & H \\ - H & H & - H & - H & H & - H & H & H & H & - H & H & H & H & - H & H & H \\ - H & - H & H & - H & H & H & - H & H & H & H & - H & H & H & H & - H & H \\ - H & - H & - H & H & H & H & H & - H & H & H & H & - H & H & H & H & - H \\ - H & H & H & H & H & - H & - H & - H & - H & H & H & H & - H & H & H & H \\ H & - H & H & H & - H & H & - H & - H & H & - H & H & H & H & - H & H & H \\ H & H & - H & H & - H & - H & H & - H & H & H & - H & H & H & H & - H & H \\ H & H & H & - H & - H & - H & - H & H & H & H & H & - H & H & H & H & - H \\ - H & H & H & H & - H & H & H & H & H & - H & - H & - H & - H & H & H & H \\ H & - H & H & H & H & - H & H & H & - H & H & - H & - H & H & - H & H & H \\ H & H & - H & H & H & H & - H & H & - H & - H & H & - H & H & H & - H & H \\ H & H & H & - H & H & H & H & - H & - H & - H & - H & H & H & H & H & - H \\ - H & H & H & H & - H & H & H & H & - H & H & H & H & H & - H & - H & - H \\ H & - H & H & H & H & - H & H & H & H & - H & H & H & - H & H & - H & - H \\ H & H & - H & H & H & H & - H & H & H & H & - H & H & - H & - H & H & - H \\ H & H & H & - H & H & H & H & - H & H & H & H & - H & - H & - H & - H & H\end{matrix} ]$$

Please note that, in an alternative design, each element corresponding to the second type in the 4×4 orthogonal code matrix may be replaced by the 4×4 orthogonal code matrix, and each element corresponding to the first type in the 4×4 orthogonal code matrix may be replaced by the product of the 4×4 orthogonal code matrix and −1.

In addition, the 16×16 orthogonal code matrix (M=1) has characteristics similar to that of the 4×4 orthogonal code matrix (i.e., the basic unit), wherein an inner product of every two rows of the orthogonal code matrix is 0. Furthermore, each column of the orthogonal code matrix has a summation of elements equal to a same value (i.e., 4H). Besides, if M is any positive integer greater than 1, the 4_{M}×4_{M} target matrix can be generated recursively by repeating the above method in a similar way. For instance, a 64×64 orthogonal code matrix can be obtained by replacing each element corresponding to H in the 16×16 orthogonal code matrix with the 4×4 orthogonal code matrix, and multiplying the 4×4 orthogonal code matrix by −1 to replace each element corresponding to −H in the 16×16 orthogonal code matrix (or replacing each element corresponding to −H in the 16×16 orthogonal code matrix with the 4×4 orthogonal code matrix, and multiplying the 4×4 orthogonal code matrix by −1 to replace each element corresponding to H in the 16×16 orthogonal code matrix). The orthogonal code matrix generated recursively by the method would retain the characteristics that an inner product of every two rows of the orthogonal code matrix is 0, and each column of the orthogonal code matrix has a summation of elements equal to a same value. Besides, the order of each column of the 16×16 orthogonal code matrix may be exchanged arbitrarily; therefore, there would be 16! Possible settings of the 16×16 orthogonal code matrix.

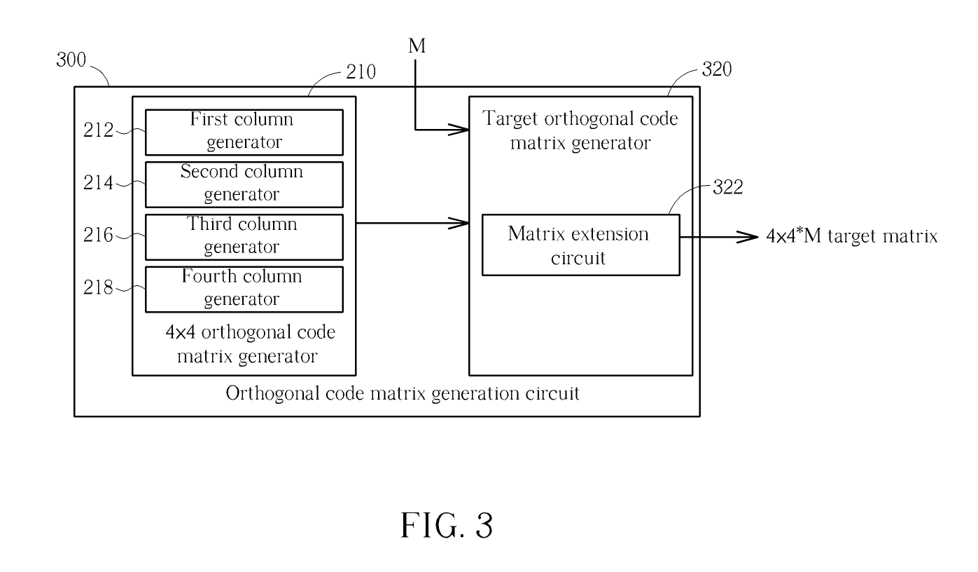

Please refer to FIG. 3, which is a diagram illustrating an orthogonal code matrix generation circuit 300 according to another exemplary embodiment of the present invention. In this embodiment, the orthogonal code matrix generation circuit 300 is used to generate an N×(N*M) target matrix. To put it another way, the orthogonal code matrix generation circuit 300 is used to generate a matrix with an order of N×(N*M), wherein N is a power of 4, and M is any positive integer greater than or equal to 1. It should be noted that, in the orthogonal code matrix generation circuit 300, a 4×4 orthogonal code matrix is employed as a basic unit to generate the 4×4*M target matrix; however, this is not a limitation of the present invention. Actually, the disclosed orthogonal code matrix generation method of the present invention may utilize any N×N orthogonal code matrix as the basic unit to establish the target matrix, wherein N is a power of 4.

As shown in FIG. 3, in this embodiment, the orthogonal code matrix generation circuit 300 includes the 4×4 orthogonal code matrix generator 210 (which is identical to the 4×4 orthogonal code matrix generator 210 in FIG. 2) and a target orthogonal code matrix generator 320. The details of the operation principle of the 4×4 orthogonal code matrix 210 are described in previous paragraphs and are omitted here for brevity. The target orthogonal code matrix generator 320 includes a matrix extension circuit 322, which has a first input terminal and a second input terminal, wherein the first input terminal is used to receive the information of the order of the 4×4*M target matrix, and the second input terminal is used to receive the 4×4 orthogonal code matrix as the basic unit. The matrix extension circuit 322 is utilized to append the 4×4 orthogonal code matrix to the 4×4 orthogonal code matrix to thereby generate a 4×(4*2) orthogonal code matrix (i.e., a 4×8 orthogonal code matrix) as follows:

$${H}_{4 , 8} = [ \begin{matrix}- H & H & H & H & - H & H & H & H \\ H & - H & H & H & H & - H & H & H \\ H & H & - H & H & H & H & - H & H \\ H & H & H & - H & H & H & H & - H\end{matrix} ]$$

It should be noted that the 4×8 orthogonal code matrix (M=1) has characteristics similar to characteristics of the 4×4 orthogonal code matrix (i.e., the basic unit), wherein an inner product of every two rows of the orthogonal code matrix is 0; in addition, each column of the orthogonal code matrix has a summation of elements equal to a same value (i.e., 2H). Furthermore, if M is any positive integer greater than 1, the 4×4*M target matrix can be generated recursively by repeating the method in a similar way. For instance, a 4×12 orthogonal code matrix can be obtained by appending the 4×4 orthogonal code matrix to the 4×8 orthogonal code matrix as follows:

$${H}_{4 , 12} = \\ [ \begin{matrix}- H & H & H & H & - H & H & H & H & - H & H & H & H \\ H & - H & H & H & H & - H & H & H & H & - H & H & H \\ H & H & - H & H & H & H & - H & H & H & H & - H & H \\ H & H & H & - H & H & H & H & - H & H & H & H & - H\end{matrix} ]$$

The orthogonal code matrix generated recursively by the method would retain the characteristics that an inner product of every two rows of the orthogonal code matrix is 0, and each column of the orthogonal code matrix has a summation of elements equal to a same value. Besides, the order of each column of the 4×12 orthogonal code matrix may be exchanged arbitrarily; therefore, there would be 12! possible settings of the 4×12 orthogonal code matrix.

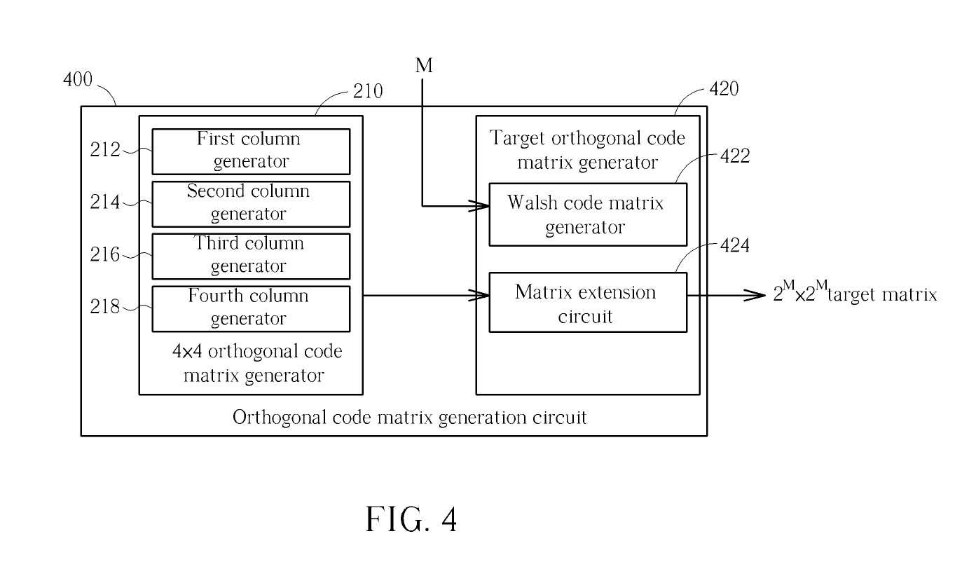

Please refer to FIG. 4, which is a diagram illustrating an orthogonal code matrix generation circuit 400 according to another exemplary embodiment of the present invention. In this embodiment, the orthogonal code matrix generation circuit 400 is used to generate a 2_{M}×2_{M} target matrix. To put it another way, the orthogonal code matrix generation circuit 400 is used to generate a matrix with an order of 2_{M}×2_{M}, wherein M is any positive integer greater than or equal to 1. It should be noted that, in the orthogonal code matrix generation circuit 300, a 4×4 orthogonal code matrix is employed as a basic unit to generate the 2_{M}×2_{M} target matrix; however, this is not a limitation of the present invention. Actually, the disclosed orthogonal code matrix generation method of the present invention may utilize any N×N orthogonal code matrix as the basic unit to establish the target matrix (premise is that the order of the target matrix should be greater than or equal to the basic unit, that is to say, 4^{M} should greater then or equal to N), wherein N is a power of 4.

As shown in FIG. 4, in this embodiment, the orthogonal code matrix generation circuit 400 includes the 4×4 orthogonal code matrix generator 210 (which is identical to the 4×4 orthogonal code matrix generator 210 in FIG. 2) and a target orthogonal code matrix generator 420. The details of the operation principle of the 4×4 orthogonal code matrix 210are described in previous paragraphs and are omitted here for brevity. The target orthogonal code matrix generator 420 is used to employ the 4×4 orthogonal code matrix as the basic unit to establish the 2_{M}×2_{M} orthogonal code matrix (wherein M is any positive integer greater than or equal to one). The target orthogonal code matrix generator 420 includes a Walsh code matrix generator 400 and a matrix extension circuit 424. The Walsh code matrix generator 422 has an input terminal used to receive the information of the order of the 2_{M}×2_{M} target matrix, wherein the 2_{M}×2_{M} target matrix is a power-of-2 orthogonal code matrix constituted by a plurality of 4×4 power basic units. For instance, if M is equal to 3, the Walsh code matrix generator 422 may generate an 8×8 Walsh code matrix first, as follows:

$${W}_{8} = [ \begin{matrix}H & H & H & H & H & H & H & H \\ H & - H & H & - H & H & - H & H & - H \\ H & H & - H & - H & H & H & - H & - H \\ H & - H & - H & H & - H & H & H & - H \\ H & H & H & H & - H & - H & - H & - H \\ H & - H & H & - H & - H & H & - H & H \\ H & H & - H & - H & - H & - H & H & H \\ H & - H & - H & H & - H & H & H & - H\end{matrix} ]$$

The 8×8 Walsh code matrix may be rewritten as

$${W}_{8} = [ \begin{matrix}{W}_{4} & {W}_{4} \\ {W}_{4} & - {W}_{4}\end{matrix} ] ,$$

wherein

$${W}_{4} = [ \begin{matrix}H & H & H & H \\ H & - H & H & - H \\ H & H & - H & - H \\ H & - H & - H & H\end{matrix} ] .$$

The matrix extension circuit 424 has an input terminal used to receive the 4×4 orthogonal code matrix as the basic unit. The matrix extension circuit 424 may use the 4×4 orthogonal code matrix

$${H}_{4} = [ \begin{matrix}- H & H & H & H \\ H & - H & H & H \\ H & H & - H & H \\ H & H & H & - H\end{matrix} ]$$

as the basic unit to replace the aforementioned

$${W}_{4} , \\ i . e . , \\ {W}_{8} = [ \begin{matrix}{H}_{4} & {H}_{4} \\ {H}_{4} & - {H}_{4}\end{matrix} ] = [ \begin{matrix}- H & H & H & H & - H & H & H & H \\ H & - H & H & H & H & - H & H & H \\ H & H & - H & H & H & H & - H & H \\ H & H & H & - H & H & H & H & - H \\ - H & H & H & H & H & - H & - H & - H \\ H & - H & H & H & - H & H & - H & - H \\ H & H & - H & H & - H & - H & H & - H \\ H & H & H & - H & - H & - H & - H & H\end{matrix} ] .$$

It should be noted that the 8×8 orthogonal code matrix (M=1) has characteristics similar to characteristics of the 4×4 orthogonal code matrix (i.e., the basic unit), wherein an inner product of every two rows of the orthogonal code matrix is 0. However, due to that the 8×8 orthogonal code matrix still retains a portion of the characteristics of the Walsh code, each column of the orthogonal code matrix does not have a summation of elements equal to a same value. For instance, in this case, the summations, each derived from elements of one column, are 4,4,4,4,0,0,0, and 0. However, compared to the conventional 8×8 Walsh code matrix with the summations 8, 0, 0, 0, 0, 0, 0, and 0, the maximum difference between the summations, each derived from elements of one column of the disclosed 8×8 Walsh code matrix according to the present invention, is 4. That is to say, the maximum difference between columns is improved from 8 (which is the maximum difference between columns of the conventional 8×8 Walsh code matrix) to 4. Besides, the order of columns of the 8×8 orthogonal code matrix may be exchanged arbitrarily; therefore, there would be 8! possible settings of the 16×16 orthogonal code matrix.

In addition, if M is any positive integer greater than 1, the 2_{M}×2_{M} target matrix can be generated recursively by repeating the method in a similar way. For instance, a 32×32 orthogonal code matrix can be obtained by replacing each W₄ in the 32×32 Walsh code matrix with the 4×4 orthogonal code matrix, and multiplying the 4×4 orthogonal code matrix by −1 to replace each −W₄ in the 32×32 Walsh code matrix. The orthogonal code matrix generated recursively by the method would retains the characteristics that an inner product of every two rows of the orthogonal code matrix is 0, and the maximum difference between the summations, each derived from elements of one column, is reduced by half compared to the conventional Walsh code with the same order.

Compared to the conventional Walsh code, the target orthogonal code matrix using the disclosed N×N orthogonal code matrix (e.g., a 4×4 orthogonal code matrix) as the basic unit can at least reduce the differences between the summations, each derived from elements of one column, by half (i.e., reduced by half or reduced to zero). Therefore, the complexity of the receiver would be reduced. For instance, the size of a capacitor in an orthogonal signal receiver may be scaled down when implemented in an integrated circuit, and thus the chip area and the cost would be reduced at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An orthogonal code matrix generation method, comprising:
establishing an N×N orthogonal code matrix, wherein an inner product of every two rows of the orthogonal code matrix is 0, and each column of the orthogonal code matrix has a summation of elements equal to a same value, where N is a power of 4; and
using the N×N orthogonal code matrix as a basic unit to establish a target orthogonal code matrix.

2. The method of claim 1, wherein N equals 4.

3. The method of claim 2, wherein the step of establishing the N×N orthogonal code matrix comprises:
using −H, H, H, and H to set one column of the N×N orthogonal code matrix;
using H, −H, H, and H to set another column of the N×N orthogonal code matrix;
using H, H, —H, and H to set another column of the N×N orthogonal code matrix; and
using H, H, H, and −H to set another column of the N×N orthogonal code matrix, wherein H is a non-zero real number.

4. The method of claim 1, wherein the step of using the N×N orthogonal code matrix as the basic unit to establish the target orthogonal code matrix comprises:
generating an N²×N² orthogonal code matrix by replacing each element corresponding to a first type in the N×N orthogonal code matrix with the N×N orthogonal code matrix, and multiplying the N×N orthogonal code matrix by −1 to replace each element corresponding to a second type in the N×N orthogonal code matrix;
wherein the target orthogonal code matrix is generated according to at least the N²×N² orthogonal code matrix.

5. The method of claim 1, wherein the step of using the N×N orthogonal code matrix as the basic unit to establish the target orthogonal code matrix comprises:
appending the N×N orthogonal code matrix to the N×N orthogonal code matrix to generate an N×(N*2) orthogonal code matrix;
wherein the target orthogonal code matrix is generated according to at least the N×(N*2) orthogonal code matrix.

6. The method of claim 1, wherein the step of using the N×N orthogonal code matrix as the basic unit to establish the target orthogonal code matrix comprises:
generating a power-of-2 N×N orthogonal code matrix constituted by a plurality of N×N power basic units; and
replacing each of the plurality of N×N power basic units with the N×N orthogonal code matrix to generate the target orthogonal code matrix.

7. An orthogonal code matrix generation circuit, comprising:
an N×N orthogonal code matrix generator, arranged for establishing an N×N orthogonal code matrix, wherein an inner product of every two rows of the orthogonal code matrix is 0, and each column of the orthogonal code matrix has a summation of elements equal to a same value, where N is a power of 4; and
a target orthogonal code matrix generator, arranged for using the N×N orthogonal code matrix as a basic unit to establish a target orthogonal code matrix.

8. The circuit of claim 7, wherein N equals 4.

9. The circuit of claim 8, wherein the N×N orthogonal code matrix generator comprises:
a first column generator, arranged for using −H, H, H, and H to set one column of the N×N orthogonal code matrix;
a second column generator, arranged for using H, −H, H, and H to set another column of the N×N orthogonal code matrix;
a third column generator, arranged for using H, H, −H, and H to set another column of the N×N orthogonal code matrix; and
a fourth column generator, arranged for using H, H, H, and −H to set another column of the N×N orthogonal code matrix, wherein H is a non-zero real number.

10. The circuit of claim 7, wherein the target orthogonal code matrix generator comprises:
a matrix extension circuit, arranged for generating an N²×N² orthogonal code matrix by replacing each element corresponding to a first type in the N×N orthogonal code matrix with the N×N orthogonal code matrix, and multiplying the N×N orthogonal code matrix by −1 to replace each element corresponding to a second type in the N×N orthogonal code matrix;
wherein the matrix extension circuit generates the target orthogonal code matrix according to at least the N²×N² orthogonal code matrix.

11. The circuit of claim 1, wherein the target orthogonal code matrix generator comprises:
a matrix extension circuit, arranged for appending the N×N orthogonal code matrix to the N×N orthogonal code matrix to generate an N×(N*2) orthogonal code matrix;
wherein the matrix extension circuit generates the target orthogonal code matrix according to at least the N×(N*2) orthogonal code matrix.

12. The circuit of claim 1, wherein the target orthogonal code matrix generator comprises:
a Walsh code matrix generator, arranged for generating a power-of-2 N×N orthogonal code matrix constituted by a plurality of N×N power basic units; and
a matrix extension circuit, arranged for replacing each of the plurality of N×N power basic units with the N×N orthogonal code matrix to generate the target orthogonal code matrix.
